(19) United States
(12) Patent Application Publication
(10) Pub. No.: US 2012/0308003 A1
(43) Pub. Date: Dec. 6, 2012

(54) AUTHENTIC BARCODES USING DIGITAL SIGNATURES

(75) Inventor: Anirban MUKHERJEE, Bangalore (IN)

(73) Assignee: VeriSign, Inc.

(21) Appl. No.: 13/118,680

(22) Filed: May 31, 2011

(51) Int. Cl. G06K 5/00; G06K 19/06; H04N 1/44; G06F 17/00

(52) U.S. Cl. 380/243; 235/375; 235/494; 235/380

(57) ABSTRACT

Methods and systems for generating and authenticating barcodes using digital signatures comprise: inputting graphical data representing a barcode pattern into memory; translating the graphical data into barcode information according to a standard for translating a particular type of barcode pattern into barcode information; extracting a message and a digital signature from the barcode information; and determining whether the message is authentic by determining whether the digital signature matches the message.

### TECHNICAL FIELD

The present disclosure relates generally to methods and systems for generating and authenticating barcodes using digital signatures.

### BACKGROUND

As more and more business, governmental, academic, and scientific operations become increasingly computer-enabled and, thus, dependent on the storage and manipulation of electronic or digital information, a greater need arises for efficient mechanisms for converting “physical” information into electronic or digital information capable of storage and manipulation by computers.

“Physical” information may include essentially any kind of information that is stored primarily in tangible, physical form, such as on paper, and is not readily available in electronic or digital form, but must instead be converted or translated into electronic or digital form through the use of electronic devices and/or manual human data-entry. For example, a utility bill printed on a piece paper received by a customer may be a form of “physical” information. Although the information printed on the utility bill may already exist in electronic or digital form—for example, in a commercial database operated by the utility company—that electronic information may not be available to the customer. Instead, if the customer wishes to store or manipulate the information printed on the paper document using a computer, he or she must either manually enter the information into a computer program or use a device, such as a scanner, that is designed to convert physical information into electronic or digital information.

Although the scanner in the above the example may effectively convert physical information to electronic information by generating a digital image of the scanned paper, because the printed bill would likely have not been formatted in a manner tailored to machine scanning and information extraction, the data captured from scanning the paper may include significant unnecessary graphical data or “noise.” Or, the scanner may not accurately read various characters, depending on the size of the font or the resolution of the scan. One solution that has been developed to address the need for efficiently and accurately converting physical information to electronic or digital information is the barcode.

A barcode is an optical, machine-readable image in which the information sought to be communicated by the barcode is arranged as a series of parallel lines of varying widths and spacings. Barcodes are typically scanned in a one-dimensional fashion by special-purpose optical scanning devices that are able to decode the information encoded in the barcodes by measuring the widths and spacings of the parallel barcode lines through reflective light feedback.

Traditional barcodes, however, suffer from the drawback that their one-dimensional structure allows for only a limited amount of information to be encoded in the barcode. For example, a Universal Product Code (UPC), which is a one-dimensional barcode format that enjoys widespread usage today, is capable of encoding only 12 decimal digits or a total of 95 bits, including start and end patterns. Because of this limitation, the last couple decades have seen significant growth in the number of standards for two-dimensional or “matrix” barcodes.

Many matrix barcodes mimic the functionality of traditional one-dimensional barcodes by providing a pattern of two-dimensionally arranged squares or other shapes of varying lengths and widths. One example of a type of matrix barcode that has enjoyed popular usage is the Quick Response or “QR” Code standard, an example of which is depicted in FIG. 1. Governed by several standards, QR Codes are capable of storing up to 7,089 numeric code characters, 4,296 alphanumeric characters, or 2,953 bytes when encoding purely binary data.

Although by no means a new standard, QR Codes have recently gained widespread use as a result of the advancement of mobile devices, such as smartphones, capable of reading and quickly rendering barcode data such as QR Codes. One common use of QR Codes, as depicted in FIG. 1, has been to encode Uniform Resource Locators (“URLs”), such as website addresses, within QR Codes placed on billboards, mailers, or even buildings to provide consumers with a quick and easy way to visit a company's website without having to memorize, write down, or manually type a URL into a smartphone or other mobile device. Consumers who see a QR Code displayed may take a picture of the QR Code using a camera embedded in the smartphone, for example, and may utilize a smartphone application to automatically translate the QR Code to a URL and launch a browser application pointed to the URL. Additional commercial uses of QR Codes include encoding coupons or other purchase information into QR Codes that customers may decode into graphical or textual coupons to present at businesses to receive discounts on purchased goods or services.

However, a significant drawback to QR Codes, or any barcodes for that matter, is that they lack any inherent security mechanism for verifying that information encoded therein actually originated from the author from which it may be assumed, expected, or required that the information have originated, or for verifying that the encoded information has not been modified by a third party. For example, although a business could display a QR Code, such as the QR Code depicted in FIG. 1, outside or within its premises to advertise its website address, a competitor could surreptitiously overlay a second QR Code over the original QR Code that, when decoded by customers' mobile devices, would direct customers to the competitor's website or to an impostor website intended to mimic the website specified by the original QR Code, for example to steal passwords or identity information. Similarly, customers providing or decoding QR Codes for the purpose of obtaining coupons or discounts could potentially print out or display forged QR Codes that fraudulently entitle them to increased discounts or rewards. Moreover, in most cases, it would be difficult to detect any forgery or modification of a QR Code using purely visual inspection, given the generally non-human readable nature of QR Codes.

Thus there is a need for methods and systems for incorporating verification mechanisms directly into barcodes, such as QR Codes, or other physical “hardlinks.”

### SUMMARY OF THE INVENTION

The invention comprises methods and systems for generating and authenticating barcodes, such as QR codes, using digital signatures. The invention provides functionality for a creator or “author” of a message to generate a barcode that includes not only the author's message, but also a digital signature associated with the message. The digital signature associated with the message may be generated by encrypting the message, or a digest of the message, using the author's private key.

A user may read the barcode using a barcode reader device, such as a smartphone or other mobile device that includes hardware and/or software for optically reading graphical barcode data and decoding the same to derive alphanumeric or binary barcode information, including a message, such as a URL, e-mail address, or image. The barcode reader may verify the authenticity of the message by decrypting the digital signature using the author's public key and confirming that the decrypted digital signature matches the barcode message.

In one embodiment, the author may include a copy of its public key certificate, such as an X.509 certificate, in the barcode, and the barcode reader may use the public key contained in the public key certificate to decrypt the digital signature and verify the authenticity of the message. In another embodiment, the author may include author identification information in the barcode in place of a public key certificate. The barcode reader may thereafter request a copy of the author's public key certificate from a verification service provider, such as a Certificate Authority, using the author identification information.

In another embodiment, the barcode reader may transmit all information necessary to determine the authenticity of the barcode message, for example the barcode message, digital signature, and author identification information, to a separate or remote verification service provider. The verification service provider may retrieve the public key certificate associated with the author identification information, and may determine the authenticity of the barcode message by determining whether the digital signature, as decrypted by the public key contained in the public key certificate, matches the barcode message. The verification service provider may then transmit the results of its authenticity determination back to the barcode reader device.

Using these techniques and/or variations derived from these techniques, users can be certain that digitally signed barcode messages purported to be from particular authors or entities in fact originated from those authors or entities, and were not tampered with prior to being optically scanned by the user's barcode reader device.

The invention may be applied to any type of barcode standard, including 2-dimensional matrix barcodes, such as QR codes.

Additional objects and advantages of the invention will be set forth in part in the description that follows, and in part will be obvious from the description, or may be learned by practice of the invention. The objects and advantages of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this specification, illustrate various embodiments of the invention and, together with the description, serve to explain the principles of the invention. In the drawings:

FIG. 1 depicts an exemplary, conventional QR code, consistent with certain disclosed embodiments;

FIG. 2 is a diagram depicting an exemplary device for generating authentic barcodes, consistent with certain disclosed embodiments;

FIG. 3 is a flow diagram illustrating an exemplary method of generating an authentic barcode including a digitally signed message and a public key certificate corresponding to the digital signature, consistent with certain disclosed embodiments;

FIG. 4 is a diagram depicting various data input and output operations associated with an exemplary method of generating an authentic barcode, consistent with certain disclosed embodiments;

FIG. 5 is a flow diagram illustrating an exemplary method of generating an authentic barcode that includes a digitally signed message and an author identifier associated with the encryption key used to generate the digital signature, consistent with certain disclosed embodiments;

FIG. 6 is a diagram depicting various data input and output operations associated with an exemplary method of generating an authentic barcode, consistent with certain disclosed embodiments;

FIG. 7 is a diagram depicting an exemplary device for reading and verifying authentic barcodes, consistent with certain disclosed embodiments;

FIG. 8 is a flow diagram illustrating an exemplary method of reading and authenticating an authentic barcode that includes a public key certificate, consistent with certain disclosed embodiments;

FIG. 9 is a diagram depicting various data input and output operations associated with an exemplary method of reading and authenticating an authentic barcode that includes a public key certificate, consistent with certain disclosed embodiments;

FIG. 10 is a flow diagram illustrating an exemplary method of reading and locally authenticating an authentic barcode that includes an author identifier, consistent with certain disclosed embodiments;

FIG. 11 is a diagram depicting various data input and output operations associated with an exemplary method of reading and locally authenticating an authentic barcode that includes an author identifier, consistent with certain disclosed embodiments;

FIG. 12 is a flow diagram illustrating an exemplary method of reading and remotely authenticating an authentic barcode that includes an author identifier, consistent with certain disclosed embodiments;

FIG. 13 is a diagram depicting various data input and output operations associated with an exemplary method of reading and remotely authenticating an authentic barcode that includes an author identifier, consistent with certain disclosed embodiments;

FIG. 14 depicts an exemplary technique for affixing an authentic bar code to physical information for the purpose of authenticating that physical information, consistent with certain disclosed embodiments;

FIG. 15 depicts an exemplary authentic bar code, consistent with certain disclosed embodiments;

FIG. 16 depicts the decoded information contained in the authentic bar code of FIG. 15;

FIG. 17 depicts an exemplary technique for affixing an authentic bar code to physical information for the purpose of authenticating that physical information, consistent with certain disclosed embodiments;

FIG. 18 depicts an exemplary authentic bar code, along with its decoded text, consistent with certain disclosed embodiments;

FIG. 19 depicts an exemplary technique for affixing an authentic bar code to physical information for the purpose of authenticating that physical information, consistent with certain disclosed embodiments; and

FIG. 20 depicts an exemplary authentic bar code, along with its decoded text, consistent with certain disclosed embodiments.

### DETAILED DESCRIPTION OF THE INVENTION

The following detailed description refers to the accompanying drawings. Wherever possible, the same reference numbers are used in the drawings and the following description to refer to the same or similar parts. While several exemplary embodiments and features of the invention are described herein, modifications, adaptations, and other implementations are possible, without departing from the spirit and scope of the invention. Accordingly, the following detailed description does not limit the invention. Instead, the proper scope of the invention is defined by the appended claims.

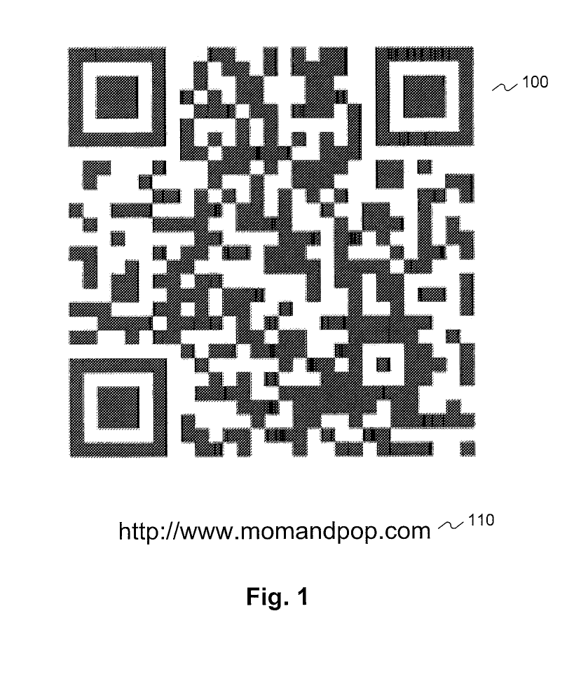

FIG. 1 depicts an exemplary, conventional QR code, consistent with certain disclosed embodiments. In the QR Code 100, information representing a URL 110 is encoded as a series of black and white boxes arranged in two dimensions.

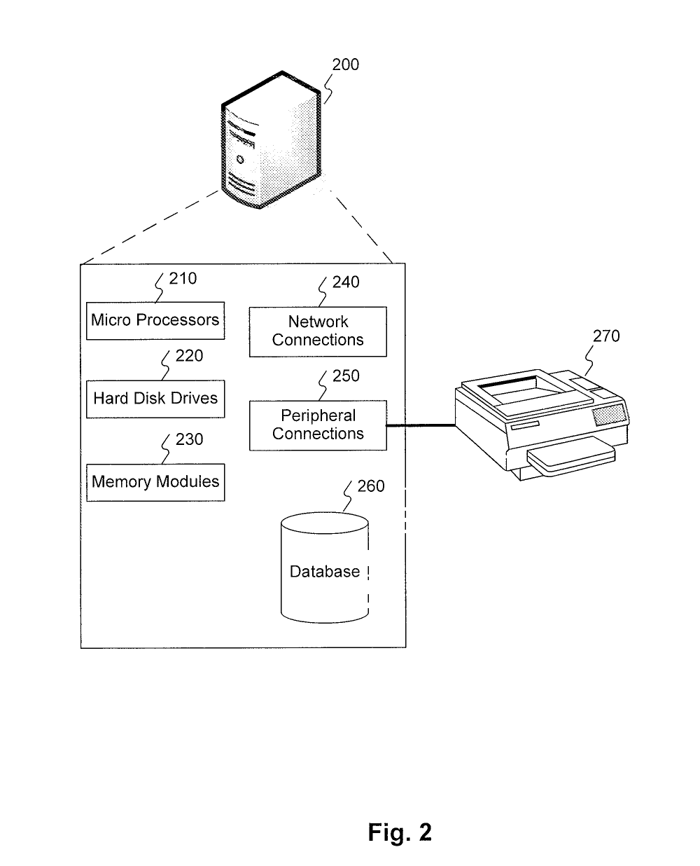

FIG. 2 is a diagram depicting an exemplary device for generating authentic barcodes, consistent with certain disclosed embodiments. Device 200 may be essentially any kind of computing device capable of inputting information; operating on that information by performing cryptographic operations, for example, utilizing exponentiation and modulo arithmetic; and outputting the results of any cryptographic operations. For example, device 200 may be a general purpose computer, comprising one or more micro processors 210 of varying core configurations and clock frequencies; one or more hard disk drives 220 of varying physical dimensions and storage capacities; one or more random access memory (RAM) modules 230 of varying clock frequencies and memory bandwidth; one or more input/output network connections 240; and one or more peripheral connections or interfaces 250. Device 200 may include or be operatively connected—e.g., by network or wireless connection—to printing device 270 capable of printing any generated barcodes on a number of physical materials, such as paper, plastic, billboard material, etc. Those skilled in the art will appreciate that device 200 or the owner or operator associated with device 200 need not necessarily print or graphically render any barcodes that it generates, but instead may provide electronic or digital data representative of generated barcodes to third parties for printing or distributing the barcodes in other manners.

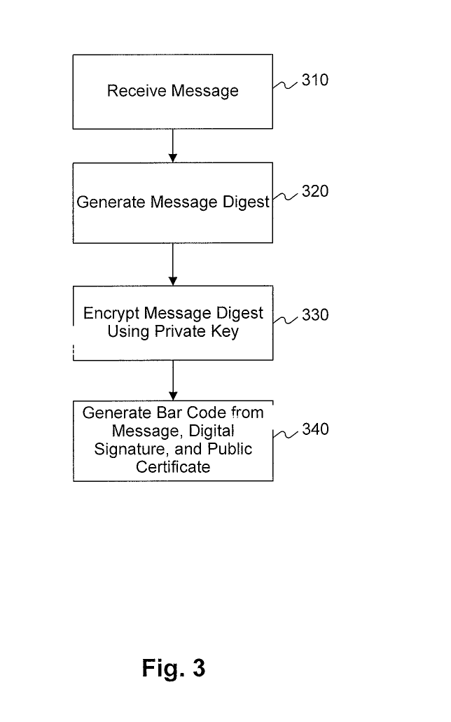

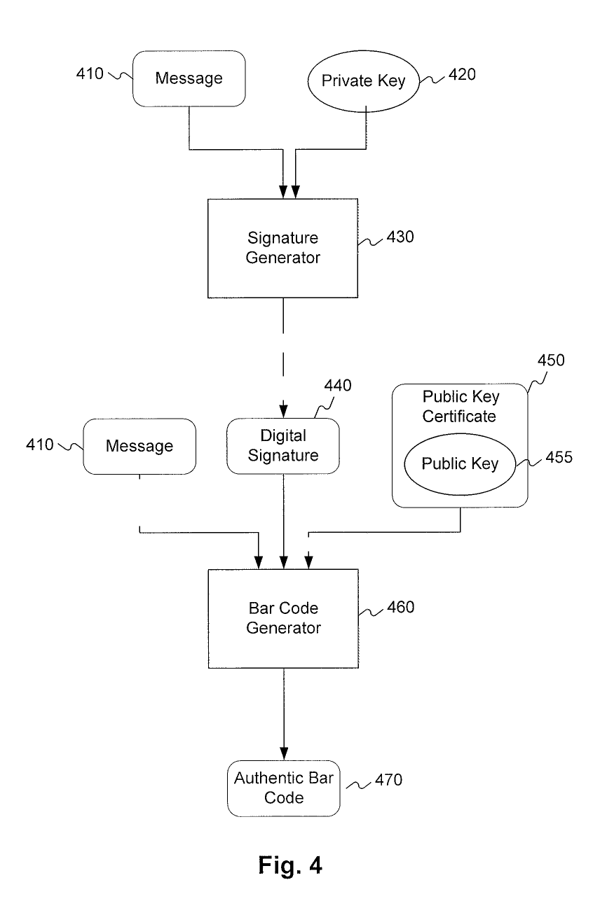

FIG. 3 is a flow diagram illustrating an exemplary method of generating an authentic barcode including a digitally signed message and a public key certificate corresponding to the digital signature, according to data operations depicted in FIG. 4, and consistent with certain disclosed embodiments. In step 310, a message 410 is selected for encoding into a barcode and is input into a barcode generation process or device, such as device 200. Message 410 may be any kind of numeric or alphanumeric text string, such as a URL, email address, coupon code, etc.; or binary data, such as an image, sound clip, application-specific file type, etc.

Next, device 200 generates a digital signature of the message using a private key associated with the author of the message. Those skilled in the art will appreciate that an “author” of a digitally signed barcode need not indicate the literal author of the information encoded in the barcode or the entity responsible for generating the actual barcode patterns. Rather, in some embodiments, the term “author” may simply indicate any party or entity for which a user or barcode reader expects or requires the barcode information to have originated from, be attributed to, or be endorsed by in some manner in order to be considered authentic.

In one embodiment, as depicted in FIGS. 3-4, device 200 may first create a digest of message 410 using techniques known in the art, such as hashing according to the MD5 or SHA-1 algorithms (step 320). In step 330, device 200 creates a digital signature 440 of the message 410 by digitally encrypting the message 410 or a digest of the message 410 using the author's private key 420. Device 200 may be configured to encrypt a digest of message 410, rather than the entire message in order to reduce the necessary size of the digital signature—for example, to ensure that the addition of the digital signature does not cause the data to be encoded in the barcode to exceed certain size limitations for barcode data, or to reduce the necessary granularity of the barcode to reduce the likelihood of machine reading errors.

Alternatively, message 410 itself, or a portion thereof, may be encrypted using the author's private key, so that the length of the digital signature is approximately proportional to the length of the message itself. Message 410 might also first be compressed, using any one of many compression techniques known in the art, and that compressed data may be digitally signed. Since those skilled in the art will appreciate that the invention may generate digital signatures based on either message digests or the messages themselves, the terms “message” and “message digest” may be used interchangeably throughout this application. Device 200 may generate the digital signature 440, for example, using a dedicated signature generating software or hardware component 430.

In step 340, device 200 generates a barcode 470 that includes a graphical representation of information comprising the message 410, the digital signature 440 of the message or message digest, and a public key certificate 450. Public key certificate 450 may include a public key 455 corresponding to the author's private key 420. Public key certificate 450 may also include information identifying the holder of the public key (not depicted), and may itself be digitally signed by a trusted third party, such as the Certificate Authority that issued the certificate to the author. Device 200 may generate the barcode 470, for example, using a dedicated barcode generating software or hardware component 460. Those skilled in the art will appreciate that foregoing steps need not be performed within a single hardware device, as, for example, a first device could be responsible for generating digital signatures 440, and a second device could be responsible for generating barcodes 470.

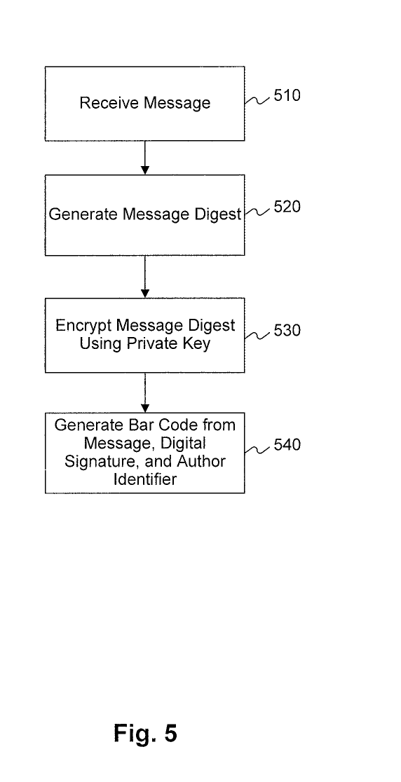

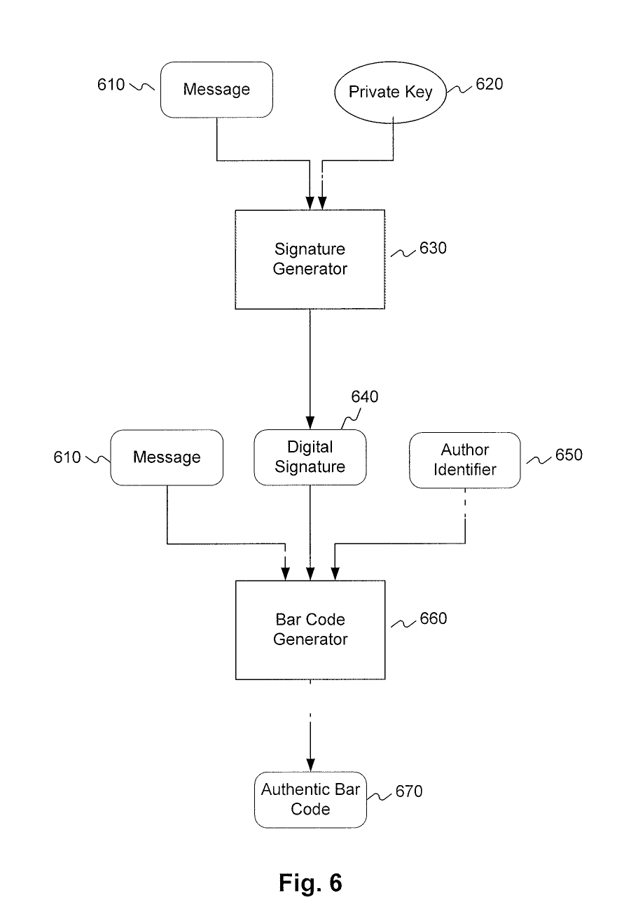

Just as it may be desirable to create a digital signature based on a hash or digest of the message, rather than a digital signature based on the message itself, in order to reduce the amount of data to be encoded within the barcode, in some cases, it may be desirable to further reduce the amount of barcode information by generating a barcode that does not include a full public key certificate, but includes only an identifier associated with the author of the message. FIG. 5 is a flow diagram illustrating an exemplary method of generating an authentic barcode including a digitally signed message and an author identifier associated with the key used to generate the digital signature, according to data operations depicted in FIG. 6, consistent with certain disclosed embodiments.

In step 510, a message 610 is selected for encoding into a barcode and is input into a barcode generation process or device, such as device 200. In step 520, device 200 creates a digest of message 610 using techniques known in the art, such as MD5 hashing or SHA-1 hashing. In step 530, device 200 creates a digital signature 640 of the message 610 by digitally encrypting the message 610 or a digest of the message 610 using the author's private key 620, for example, using a dedicated barcode generating software or hardware component 630.

At this point, rather than including a full public key certificate in the data to be encoded in the barcode, device 200 may determine an author identifier 650 associated with the message. In some embodiments, the author identifier may be the name of the entity to which the public key certificate associated with private key 620 has been issued by a Certificate Authority. In step 540, device 200 generates a barcode 670 that includes a graphical representation of information comprising the message 610, the digital signature 640 of the message or message digest, and the author identifier 650.

By including a shorter author identifier 650 in the barcode 670 instead of a longer public key certificate (which would likely also include an author identifier), less metadata should need to be encoded in barcode 670. This allows for either a longer message 610 or a simpler barcode that requires less granularity and is therefore less prone to machine-reading errors or data-density limitations.

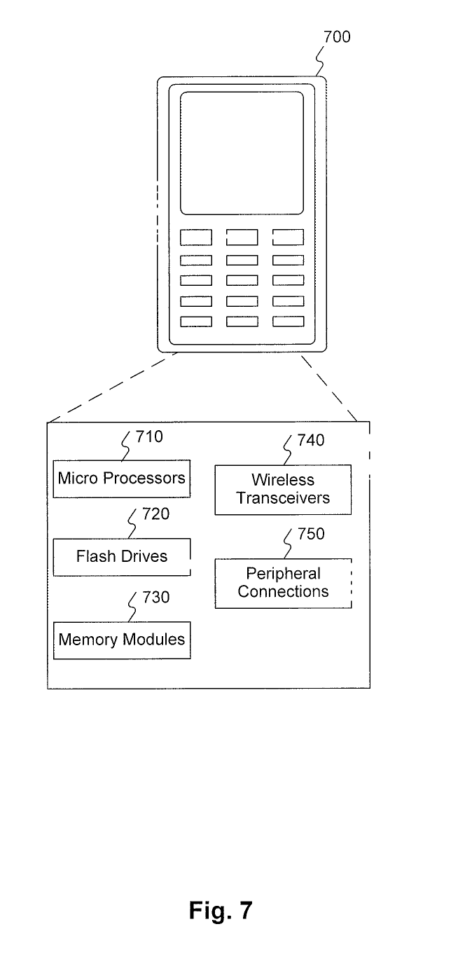

FIG. 7 is a diagram depicting an exemplary device for reading and verifying authentic barcodes, consistent with certain disclosed embodiments. Device 700 may be essentially any kind of computing device capable of optically reading graphical bar code data; decoding the graphical bar code data to derive bar code information; operating on that information by performing cryptographic operations, for example, utilizing exponentiation and modulo arithmetic; and outputting the results of any cryptographic operations. For example, device 700 may be a commercially available mobile device such as a smartphone with optical camera componentry and one or more software applications for decoding images of barcodes captured by the camera componentry. Device 700 may further comprise one or more micro processors 710 of varying core configurations and clock frequencies; one or more flash drives 720 of varying physical dimensions and storage capacities; one or more random access memory (RAM) modules 730 of varying clock frequencies and memory bandwidth; one or more wireless transceivers 740; and one or more peripheral connections or interfaces 750. Device 700 may communicate with other devices via cellular wireless access, such as using Code Division Multiple Access (“CDMA”), via wireless Ethernet protocols, or via a serial wire interface such as USB, etc.

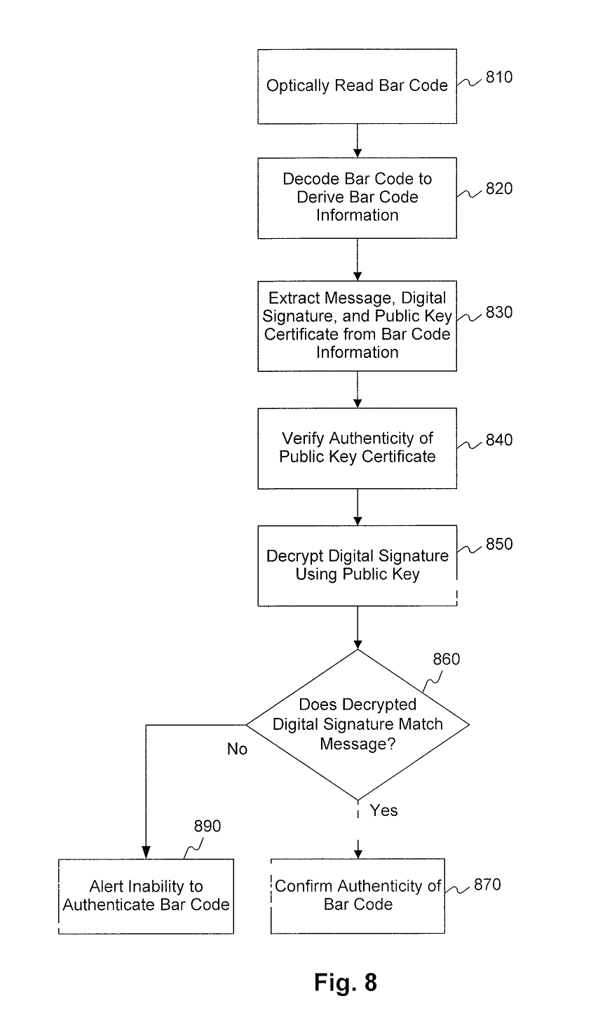

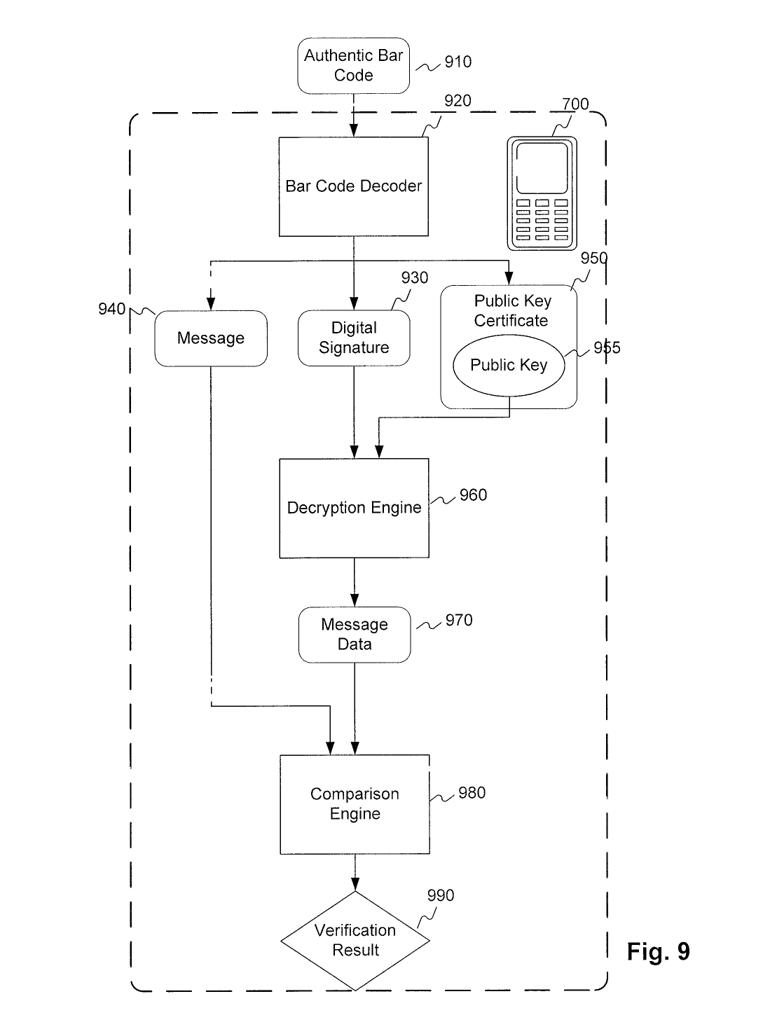

FIG. 8 is a flow diagram illustrating an exemplary method of reading and authenticating an authentic barcode that includes a public key certificate, according to data operations depicted in FIG. 9, consistent with certain disclosed embodiments. In step 810, reading device 700 optically reads a barcode 910. For purposes of this example, it will be assumed that barcode 910 is an authentic barcode generated in a manner consistent with this invention. Those skilled in the art will appreciate that device 700 may include functionality or logic for reading multiple types of barcodes and, for each type of barcode, determining whether the barcode is an authentic barcode before performing any of the below described authentication operations.

In step 820, reading device 700 decodes barcode 910 to translate the graphical patterns of the physical barcode into the information encoded within the barcode according to the standards of the relevant barcode type, for example using a dedicated barcode decoding software or hardware component 920. In step 830, reading device 700 parses the barcode information to extract a message 940, digital signature 930, and public key certificate 950, which includes a public key 955.

In step 840, reading device 700 verifies the authenticity of public key certificate 950. In particular, reading device 700 may inspect public key certificate 950 for a “Subject” indicating the holder of the certificate or the “signer” of the digital signature; an “Issuer” indicating a trusted third party, such as a Certificate Authority, responsible for issuing certificates or digitally signing certificates; and a “Thumbprint” or “Fingerprint” representing a digital signature of the public key certificate itself (or a digest of the public key certificate) signed using the Issuer's private key. Reading device 700 may verify the authenticity of public key certificate 940 by decrypting the “Thumbprint” using the Issuer's public key and confirming that the decrypted Thumbprint matches the public key certificate or digest of the public key certificate. Those skilled in the art will appreciate other methods of confirming the authenticity of public key certificate 950. Reading device 700 may also confirm that the “Subject” or “signer” of the public key certificate corresponds to the identity of an author or creator from whom the information encoded in the barcode is expected to have originated.

In step 850, reading device 700 decrypts the digital signature 930 using the public key 955 to generate message data 970, for example, using a dedicated decryption software or hardware component 960. Depending on whether the digital signature 930 was generating by digitally encrypting a digest of message 940 or by encrypting message 940 itself, message data 970 will represent either the barcode message 940 or a digest of that message.

In step 860, device 700 compares decrypted message data 970 to the barcode message 940. If decrypted message data 970 represents a message digest, then device 700 may first independently create a digest of message 940 using the same algorithm used by the author of the barcode (operations not depicted). Device 700 may then compare decrypted message data 970 to its independently generated digest of message 940 to determine whether the strings are equivalent or match in a predefined manner. If decrypted message data 970 represents a copy of the message 940 itself, then device 700 may compare the decrypted message data 970 to message 940 to determine whether the strings are equivalent or match in a predefined manner. These operations may be performed, for example, using a dedicated comparison engine software or hardware component 980.

In either case, if decrypted message data 970 matches barcode message 940 (step 860, yes), then device 700 may determine that the barcode message 940 was actually created or authored by the entity associated with public key certificate 950, since only the holder of the certificate should have had access to the private key to generate the digital signature 930 capable of decryption by the public key 955 associated with the certificate. If decrypted message data 970 does not match barcode message 940 (step 860, no), then device 700 may determine that barcode message 940 was not authored by the holder of public key certificate 950 or that barcode message 940 was altered on barcode 910 subsequent to the creation of digital signature 930 (which alteration might also be attributable to machine-reading errors). In either event, device 700 may generate a verification result 990 indicating whether it was able to authenticate barcode 910 and may take appropriate subsequent action, such as indicating that the barcode was successfully authenticated (step 870) or alerting a user that the barcode was not successfully authenticated (step 880).

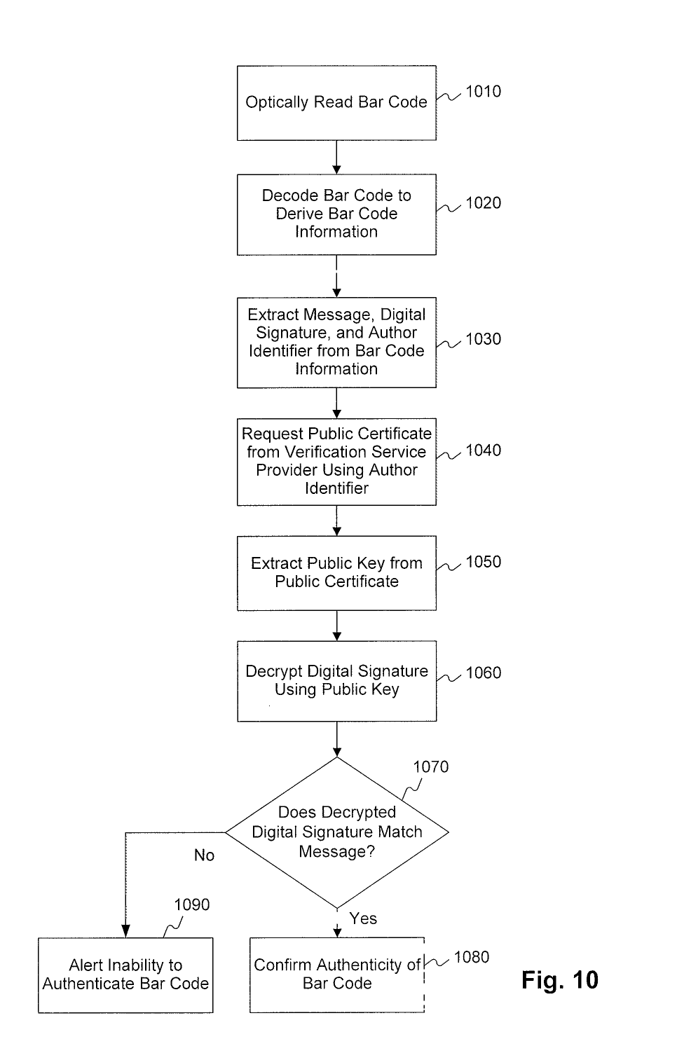

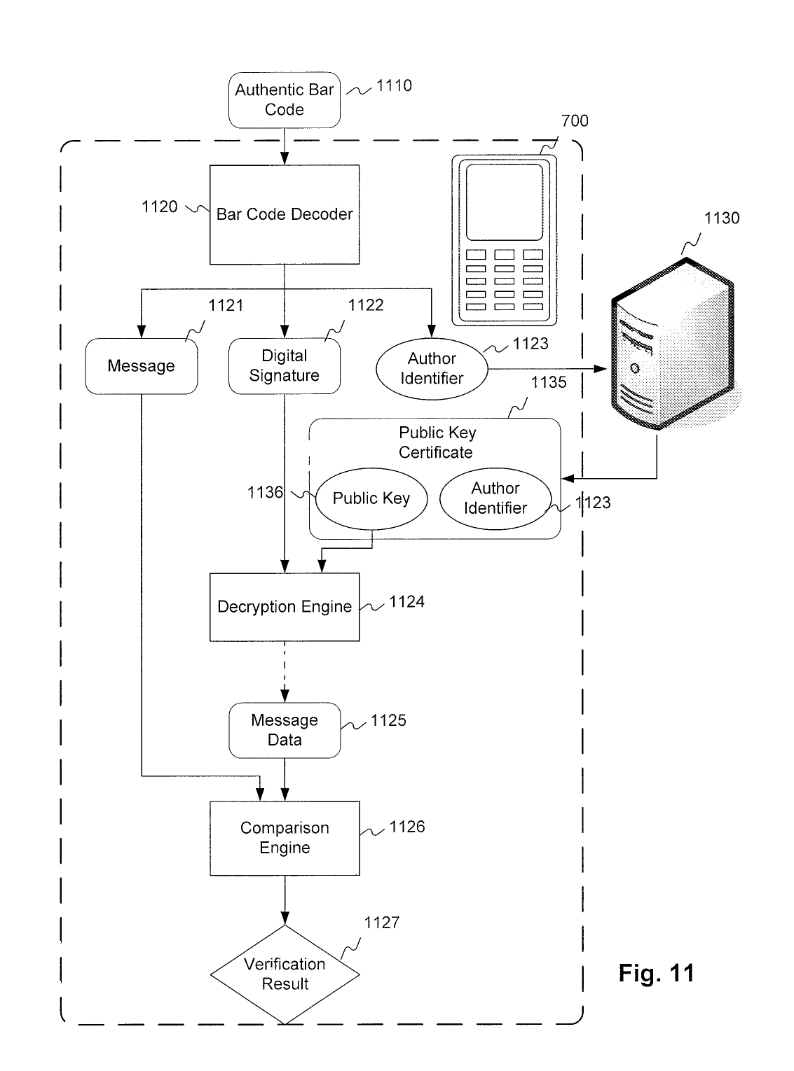

FIG. 10 is a flow diagram illustrating an exemplary method of reading and locally authenticating an authentic barcode that includes an author identifier, according to operations depicted in FIG. 11, consistent with certain disclosed embodiments. In step 1010, reading device 700 optically reads a barcode 1110. In step 1020, reading device 700 decodes barcode 1110 to translate the graphical patterns of the physical barcode into the information encoded within the barcode according to the standards of the relevant barcode type, for example using a dedicated barcode decoding software or hardware component 1120. In step 1030, reading device 700 parses the barcode information to extract a message 1121, a digital signature 1122, and an author identifier 1123. That is, rather than containing a public key certificate, as per barcode 910, barcode 1110 may include only an author identifier 1123 (e.g., for the purpose of reducing the amount of information stored in barcode 1110). Author identifier 1123 may indicate the identity of an author or creator from whom the information encoded in the barcode is expected to have originated.

At this point, if device 700 does not already have stored the public key certificate associated with author identifier 1123, then it may not be able to determine whether the message is authentic. Therefore, in step 1040, device 700 may request a copy of the author's public certificate 1135 from another device or entity, such as a verification service provider 1130. For example, device 700 may transmit a copy of the author identifier 1123 to identify the public certificate that it is requesting. Although not depicted, device 700 may further verify the authenticity of the received public key certificate 1135 in a manner similar to the certificate verification operations described with respect to FIG. 8. For example, device 700 may confirm that the “Subject” or “signer” of public key certificate 1135 corresponds to the author identifier 1123 transmitted to verification service provider 1130 to identify the requested certificate.

Those skilled in the art will appreciate that the present invention may also encompass embodiments in which barcode 1110 also does not encode any author identifier. For example, the identity of the author may be indicated by means external to the encoded barcode information, such as on a printed textual label in proximity to the barcode. Or, the present invention may be utilized in a circumstance in which the putative author of the barcode and the reader of the barcode have a preexisting relationship or defined set of operations such that the reader of barcode 1110 would expect barcode 1110 to have originated from a specific author, for which reader device 700 (or a device associated with reader device 700) already has author identity information 1123 stored. Companies, for example, may choose to rely on such an assumed-authorship model to further free up capacity within the barcode to store additional information or to further reduce the granularity of the barcode.

Once device 700 receives the public key certificate 1135 from verification service provider 1130, in step 1050, device 700 may extract the public key 1136 included in the public key certificate 1135. Thereafter, in steps 1060, 1070, 1080, and 1090, device 700 may perform operations similar to those of steps 840, 850, 860, and 870 depicted in FIG. 8. That is, device 700 may determine the authenticity of barcode 1110 by determining whether decrypted message data 1125 matches barcode message data 1121.

In another embodiment, it may be preferable to rely on a verification service provider not only to supply any public key certificates associated with the author of a digitally signed barcode, but to also perform any decryption and/or authentication operations.

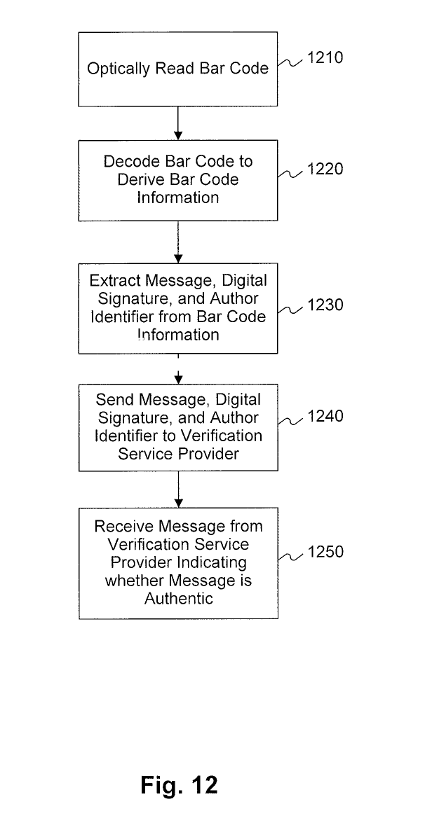

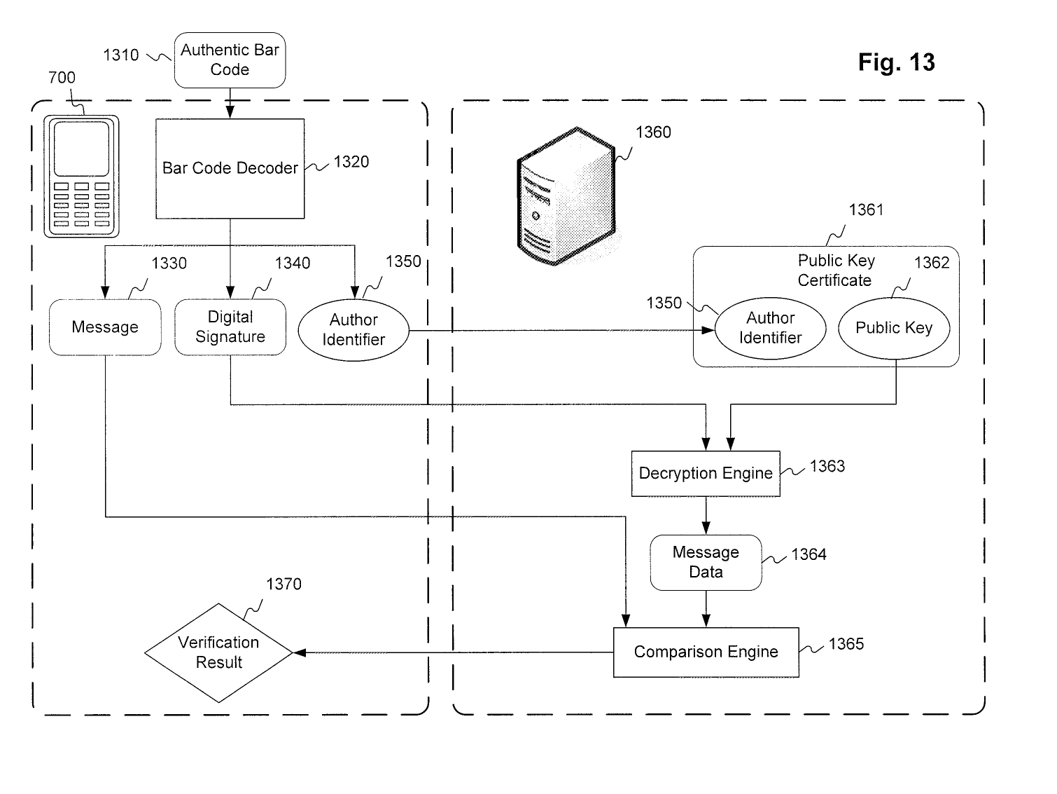

FIG. 12 is a flow diagram illustrating an exemplary method of reading and remotely authenticating an authentic barcode that includes an author identifier, according to operations depicted in FIG. 13, consistent with certain disclosed embodiments.

In step 1210, reading device 700 optically reads a barcode 1310. In step 1220, reading device 700 decodes barcode 1310 to translate the graphical patterns of the physical barcode into the information encoded within the barcode according to the standards of the relevant barcode type, for example using a dedicated barcode decoding software or hardware component 1320. In step 1230, reading device 700 parses the barcode information to extract a message 1330, a digital signature 1340, and an author identifier 1350. However, rather than request the public key certificate associated with author identifier 1350, as described with respect to FIGS. 10 and 11, device 700 may rely on a verification service to perform all necessary verification operations with respect to message 1330 and digital signature 1340.

In step 1240, device 700 may send message 1330, digital signature 1340, and author identifier 1350 to verification service provider 1360. Those skilled in the art will appreciate that device 700 may send these pieces of information to verification service provider 1360 either as art of one transmission or as part of multiple transmissions. Likewise, device 700 may transmit either message 1330 or a digest of message 1330 to verification service provider 1360, as appropriate.

Using transmitted author identifier 1350, verification service provider 1360 may access locally or request from another party, such as a Certificate Authority, the appropriate public key certificate 1361 associated with author identifier 1350. Thereafter, similar to the authentication operations performed by device 700, as depicted in FIGS. 8-12, verification service provider 1360 may decrypt digital signature 1340 using the public key 1362 included within the public key certificate 1361 associated with author identifier 1350 to derive decrypted message data 1364, for example, using a dedicated decrypting engine software or hardware component 1363.

Verification service provider 1360 may then compare decrypted message data 1364 to barcode message 1330 or to a digest of barcode message 1330 to determine whether the strings match according to a predefined pattern, for example, using a dedicated comparison engine software or hardware component 1365. Verification service provider 1360 may send the results of its comparison operations to device 700 (step 1250), and device 700 may interpret the results provided by verification service provider 1360 to determine a verification result 1370. For example, verification service provider 1360 may transmit data representative of a final conclusion as to whether the barcode message 1330 is authentic or not, or verification service provider 1360 may simply provide device 700 with the details of its comparison operations and allow device 700 to draw its own conclusion about the authenticity of barcode message 1330.

Although not depicted in any of the foregoing figures, an authentic bar code, consistent with various disclosed embodiments, may also include an indication of, or instructions for performing, a particular type of hashing or digest algorithm. The inclusion of this information may enable message digests, rather than full messages, to be digitally signed, by informing a reading device of which hashing or digest algorithm was used by the encoding device. Elliptical curve cryptography may also be used to create digital signatures to further reduce the amount of metadata needed to be encoded within an authentic bar code.

In some embodiments, the invention may also be used to define a new “purpose” for a public certificate. In particular, one extension to some public key certificate standards, such as X.509, is the ability to specify various purposes for which the public key or public key certificate may used, such as “encryption,” “signature,” “signature and encryption,” or “signature and smartcard logon.” Thus, a new purpose related to barcode authentication may be added to a public key certificate, consistent with disclosed embodiments, for specifying that a particular public key certificate may be dedicated solely to, or have as one of its purposes, the authentication of digitally signed barcodes. Moreover, some operating systems allow users to specify the purposes for which a public key certificate may be used. Thus, in some embodiments, users may limit the use of some public key certificates solely to barcode authentication, or barcode authentication along with a limited list of other valid purposes; or users may prohibit certain public key certificates from being used for barcode authentication purposes.

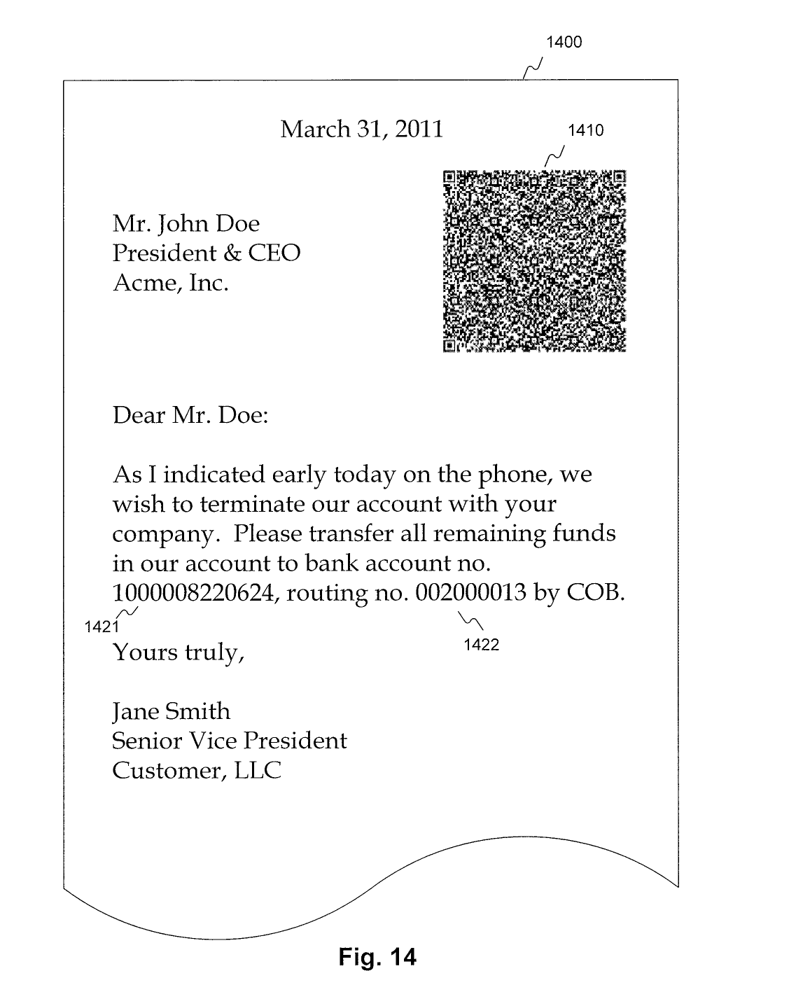

Attention will now be directed to several specific use-case embodiments of the present invention. FIG. 14 depicts an exemplary technique for affixing an authentic bar code to physical information for the purpose of authenticating that physical information, consistent with certain disclosed embodiments. The present invention is not limited to situations in which a barcode alone is to be authenticated. Rather, the invention may also be put to very practical use in authenticating information external to the digitally signed bar code, such as physical information to which the barcode is affixed.

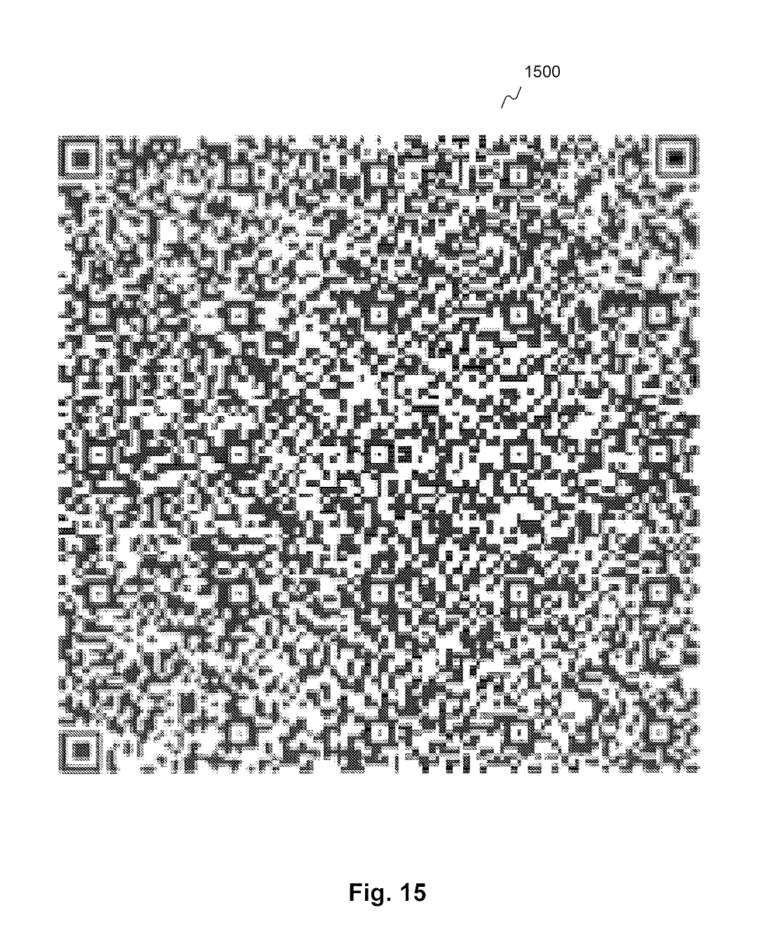

For example, as depicted in FIG. 14, physical information, such as printed text, may be embodied in a document 1400, such as a business letter or other correspondence having business or legal significance. In order to attest to the authenticity or authorship of the information set forth in the document 1400, document 1400 may also include a barcode, such as QR Code 1410, which is depicted in enlarged form as QR Code 1500 in FIG. 15.

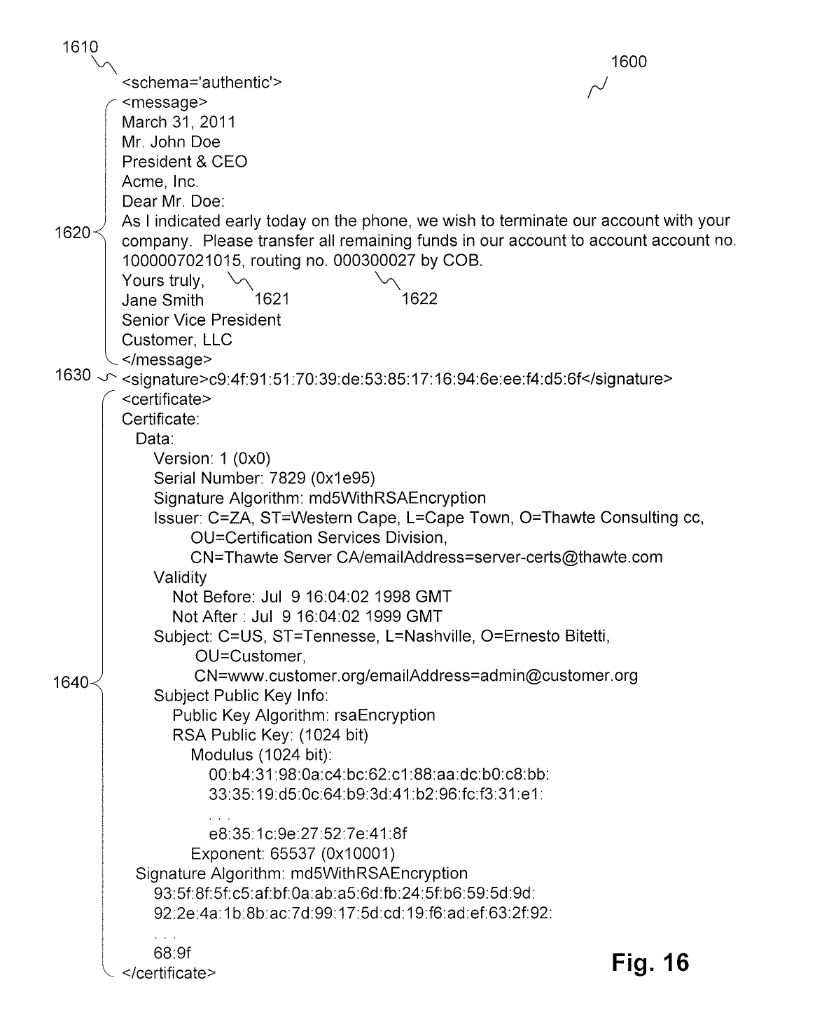

The recipient of document 1400 may scan QR Code 1410 (or 1500) using a scanning device, which device may display or provide to the recipient the information encoded within QR Code 1410, such as the information depicted in FIG. 16. As depicted in FIG. 16, the information encoded in QR Code 1410 may comprise data in form of XML-delimited text 1600.

XML text 1600 may include a schema 1610 that indicates that the XML text is meant to describe the contents of an “authentic” barcode. XML text 1600 may include a message section 1620 that the author of the QR Code attests as the text of the document to which the QR code has been affixed. XML text 1600 may also include a signature section 1630 that includes a digital signature of the message 1620 that has been created using the author's private encryption key, XML text 1600 may also include a certificate section 1640 that sets forth the data of a public key certificate that contains a public key corresponding to the private key that was used to create digital signature 1630.

The recipient of document 1400 may see that the message text 1620 of QR Code 1410 does not match the text of document 1400—here, because the account number 1421 and routing number 1422 of document 1400 do not match the account number 1621 and routing number 1622 of message text 1620. Thus, the recipient may determine that document 1400 is not authentic or has been tampered with. On the other hand, if the text of document 1400 and QR Code message text 1620 did match, the recipient could confirm the authenticity of document 1400 by confirming that digital signature 1630 of message text 1620 can be decrypted using the public key provided by public key certificate 1640, and that the decrypted digital signature matches message text 1620 or a digest thereof, since only the holder of the private key associated with public key certificate 1640 could have created digital signature 1630.

Alternatively, if both the text of document 1400 and QR Code message text 1620 matched, but decrypted digital signature 1630 did not match QR Code message text 1620, then the recipient may conclude that document 1400 and/or QR Code 1410 are forgeries, since the putative author of the document (i.e., the holder of the relevant private key) would presumably have generated a correct digital signature 1630 corresponding to message text 1620. The recipient may make a similar conclusion if public key certificate 1640 cannot be authenticated as belonging to the putative author of the document or QR Code, or if the recipient is unable to decrypt digital signature 1630 using the public key provided by public key certificate 1640.

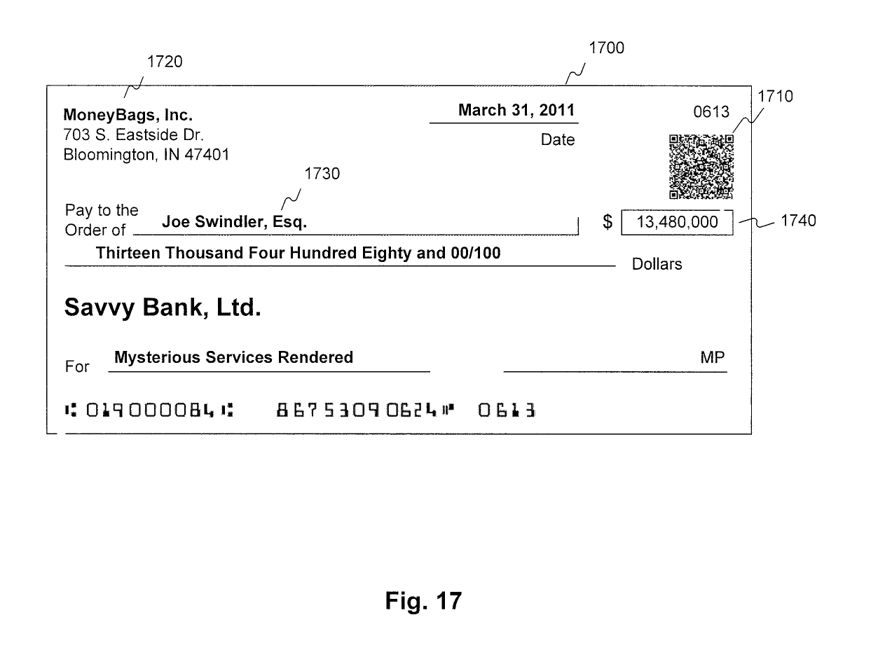

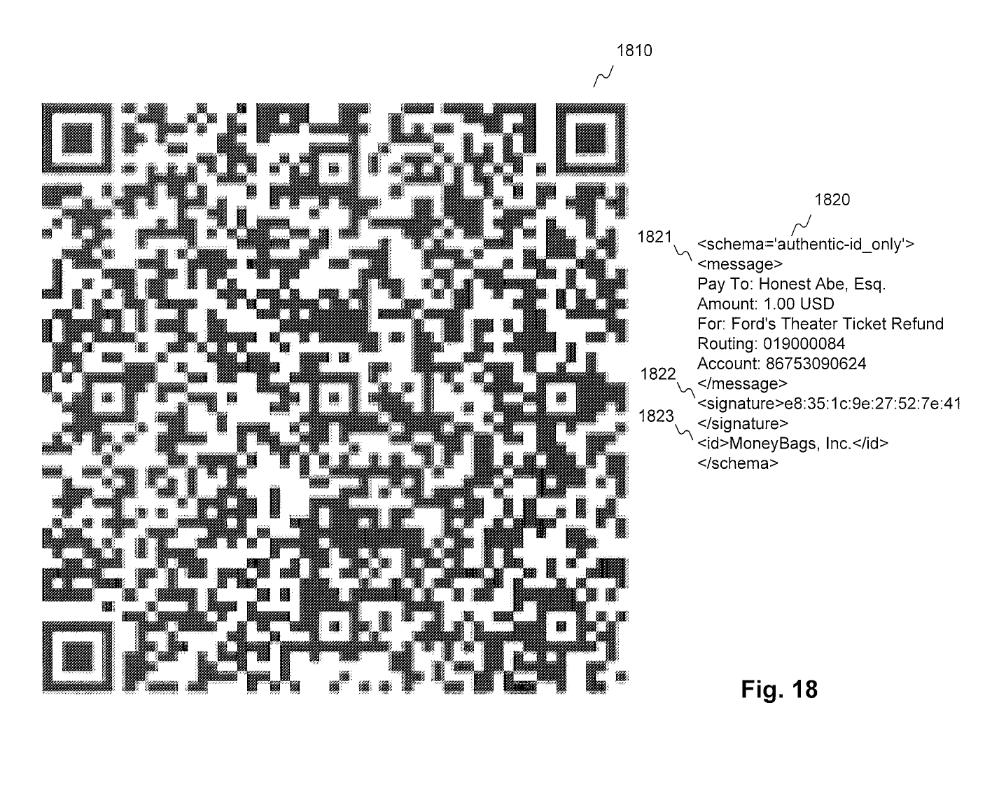

Similarly, as depicted in FIG. 17, a digitally signed barcode may be used as a security mechanism for checks, drafts, or other commercial paper. As shown in FIG. 17, a digitally signed QR Code 1710 (which is depicted in enlarged form in FIG. 18), may be affixed to a check 1700 to attest to the authenticity of the information presented on the check—here, that a particular account holder 1720 has issued a valid check to a particular recipient 1730 for a particular amount 1740.

As depicted in FIG. 18, QR Code 1710 (or 1810), may be decoded to reveal encoded textual information 1820 meant to correspond to the text of check 1700, to which it was affixed. As shown in FIG. 18, the information 1820 encoded in QR Code 1710 may comprise only a message 1821, a digital signature 1822, and an author identifier 1823. That is, an author identifier 1823 may be encoded in lieu of a full public key certificate, such that the recipient of the QR Code would be expected to retrieve the public key certificate corresponding to author identifier 1823 from a third-party, such as a Certificate Authority. Similar to the example of FIGS. 14-16, the recipient may decode QR Code 1710 and may determine that check 1700 is fraudulent since the information printed on check 1700 does not match the information 1820 of decoded QR Code 1710, or may determine authenticity or lack of authenticity based on matches or mismatches between message 1821, digital signature 1822, and author identifier 1823.

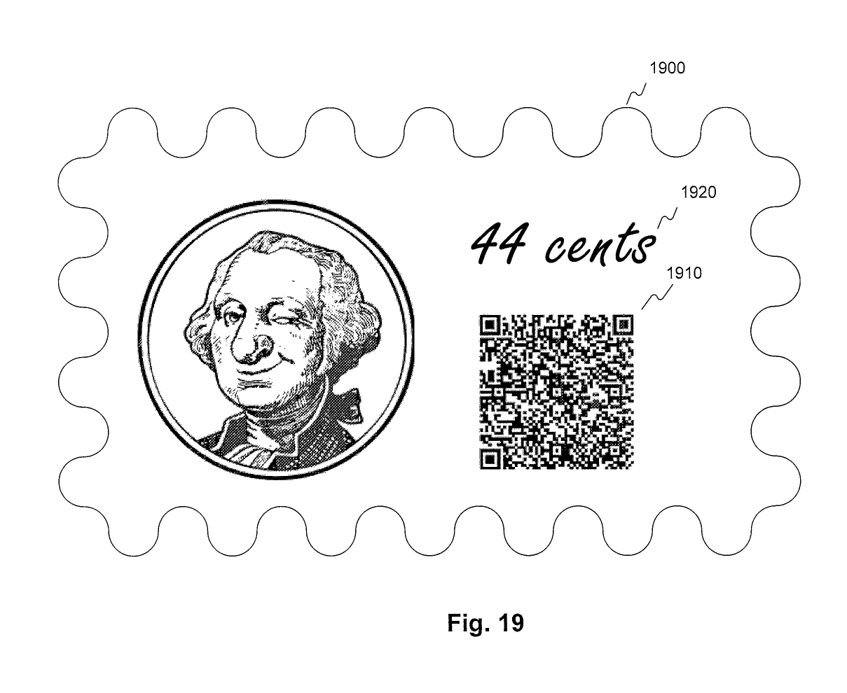

Similarly, as depicted in FIG. 19, a digitally signed barcode may be used as a security mechanism to ensure that physical information is authentic. In some situations, physical indicia may be created or affixed to an object to demonstrate that money has been paid, that various duties have been satisfied, or that an object has been authorized or issued by a given entity. A classic example may be that of a postage stamp, which is meant to demonstrate that certain postage fees have been paid or that an item is entitled to shipment. In many of these situations, if the physical indicia is capable of easy replication or creation by unauthorized parties, as is the case with postage stamps, there is the danger that affixed physical indicia may not be authentic. However, the present invention may be utilized in situations such as these to ensure authenticity.

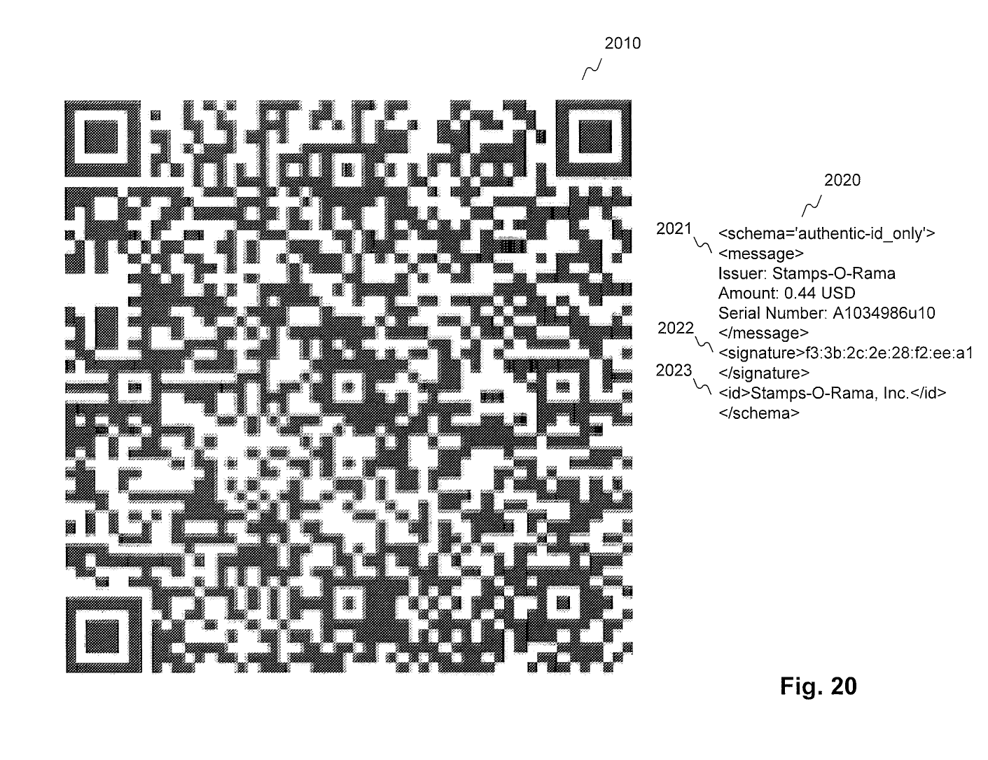

As shown in FIG. 19, a digitally signed QR Code 1910 (which is depicted in enlarged form in FIG. 20), may be affixed to a stamp (or other physical item that only certain entities are authorized to create) to attest to the authenticity of the information presented on the stamp—here, that a certain amount of postage 1920 has been paid.

As depicted in FIG. 20, QR Code 1910 (or 2010), may be decoded to reveal encoded textual information 2020 meant to correspond to the text of stamp 1900, to which it was affixed. Similar to the examples of FIGS. 14-18, the recipient, such as the U.S. Postal Service, may decode QR Code 1910 and may determine that stamp 1900 is authentic since the information printed on stamp 1900 matches the information 2020 of decoded QR Code 1910, or may determine authenticity or lack of authenticity based on matches or mismatches between message 2021, digital signature 2022, and author identifier 2023.

Those skilled in the art will appreciate that, although described primarily in the context of barcodes for optical scanning, the present invention may be applied to any situation in which physical objects or phenomena in which machine-readable information has been encoded are converted to digital or electronic data by a scanning, listening, or other detection advice. For example, the present invention may be applied to information encoded within magnetic strips, audio signals, RFID signals, and other real-world “hardlinks.”

The foregoing description of the invention, along with its associated embodiments, has been presented for purposes of illustration only. It is not exhaustive and does not limit the invention to the precise form disclosed. Those skilled in the art will appreciate from the foregoing description that modifications and variations are possible in light of the above teachings or may be acquired from practicing the invention. For example, the steps described need not be performed in the same sequence discussed or with the same degree of separation. Likewise various steps may be omitted, repeated, or combined, as necessary, to achieve the same or similar objectives. Accordingly, the invention is not limited to the above-described embodiments, but instead is defined by the appended claims in light of their full scope of equivalents.

1. A computer-implemented method of verifying the authenticity of a barcode, comprising:
inputting graphical data representing a barcode pattern into memory;
translating the graphical data into barcode information according to a standard for translating a particular type of barcode pattern into barcode information;
extracting a message and a digital signature from the barcode information; and
determining whether the message is authentic by determining whether the digital signature matches the message.

2. The method of claim 1, wherein determining whether the digital signature matches the message further comprises:
decrypting the digital signature using a digital key; and
determining whether the decrypted digital signature matches the message or a digest of the message.

3. The method of claim 2, wherein:
extracting the message and the digital signature from the barcode information further comprises extracting a public key from the barcode information; and
decrypting the digital signature comprises decrypting the digital signature using the public key.

4. The method of claim 3, wherein extracting the public key from the barcode information further comprises:
extracting a public key certificate from the barcode information; and
extracting the public key from the public key certificate.

5. The method of claim 2, further comprising:
retrieving a public key or public key certificate containing the public key from a verification service provider; and
decrypting the digital signature using the public key.

6. The method of claim 5, wherein retrieving the public key or public key certificate from the verification service provider comprises sending an author identifier to the verification service provider.

7. The method of claim 6, further comprising:
extracting the author identifier from the barcode information.

8. A computer-implemented method of verifying the authenticity of a barcode, comprising:
inputting graphical data representing a barcode pattern into memory;
translating the graphical data into barcode information according to a standard for translating a particular type of barcode pattern into barcode information;
extracting a message and a digital signature from the barcode information;
transmitting the message or a digest of the message and the digital signature to a verification service provider; and
receiving an indication from the verification service provider as to whether the message is authentic based on a determination by the verification service provider whether the digital signature matches the message or the digest of the message.

9. The method of claim 8, further comprising:
transmitting an author identifier to the verification service provider.

10. The method of claim 9, further comprising:
extracting the author identifier from the barcode information.

11. A computer-implemented method of generating a barcode capable of authentication, the method comprising:
inputting a message into memory;
generating a digital signature of the message or a digest of the message;
generating barcode information, wherein the barcode information comprises the message and the digital signature; and
generating a barcode pattern, wherein the barcode pattern represents a machine-readable, graphical representation of the barcode information according to a standard for translating barcode information to barcode patterns associated with a particular type of barcode.

12. The method of claim 11, wherein generating a digital signature of the message or the digest of the message comprises:
encrypting the message or the digest of the message using a digital key.

13. The method of claim 12, wherein encrypting the message or the digest of the message comprises:
encrypting the message or the digest of the message using a private key associated with an asymmetric public key.

14. The method of claim 13, wherein the barcode information further comprises the public key.

15. The method of claim 14, wherein the barcode information further comprises a public key certificate that includes the public key and identity information associated with the entity to whom the public key certificate has been issued by a Certificate Authority.

16. The method of claim 13, wherein the barcode information further comprises an author identifier.

17. A system for verifying the authenticity of a barcode, comprising:
a processing system comprising one or more processors; and
a memory system comprising one or more computer-readable media, wherein the computer-readable media store instructions that, when executed by the processing system, cause the system to perform the operations of:
inputting graphical data representing a barcode pattern into memory;
translating the graphical data into barcode information according to a standard for translating a particular type of barcode pattern into barcode information;
extracting a message and a digital signature from the barcode information; and
determining whether the message is authentic by determining whether the digital signature matches the message.

18. The system of claim 17, wherein determining whether the digital signature matches the message further comprises:
decrypting the digital signature using a digital key; and
determining whether the decrypted digital signature matches the message or a digest of the message.

19. The system of claim 18, the computer-readable media store instructions that:
extracting the message and the digital signature from the barcode information further comprises extracting a public key from the barcode information; and
decrypting the digital signature comprises decrypting the digital signature using the public key.

20. The system of claim 19, wherein extracting the public key from the barcode information further comprises:
extracting a public key certificate from the barcode information; and
extracting the public key from the public key certificate.

21. The system of claim 18, wherein the computer-readable media further stores instructions for:
retrieving a public key or public key certificate containing the public key from a verification service provider; and
decrypting the digital signature using the public key.

22. The system of claim 21, wherein retrieving the public key or public key certificate from the verification service provider comprises sending an author identifier to the verification service provider.

23. The system of claim 22, further comprising:
extracting the author identifier from the barcode information.

24. A system for verifying the authenticity of a barcode, comprising:
a processing system comprising one or more processors; and
a memory system comprising one or more computer-readable media, wherein the computer-readable media store instructions that, when executed by the processing system, cause the system to perform the operations of:
inputting graphical data representing a barcode pattern into memory;
translating the graphical data into barcode information according to a standard for translating a particular type of barcode pattern into barcode information;
extracting a message and a digital signature from the barcode information;
transmitting the message or a digest of the message and the digital signature to a verification service provider; and
receiving an indication from the verification service provider as to whether the message is authentic based on a determination by the verification service provider whether the digital signature matches the message or the digest of the message.

25. The system of claim 24, further comprising:
transmitting an author identifier to the verification service provider.

26. The system of claim 25, further comprising:
extracting the author identifier from the barcode information.

27. A system for generating a barcode capable of authentication, the system comprising:
a processing system comprising one or more processors; and
a memory system comprising one or more computer-readable media, wherein the computer-readable media store instructions that, when executed by the processing system, cause the system to perform the operations of:
inputting a message into memory;
generating a digital signature of the message or a digest of the message;
generating barcode information, wherein the barcode information comprises the message and the digital signature; and
generating a barcode pattern, wherein the barcode pattern represents a machine-readable, graphical representation of the barcode information according to a standard for translating barcode information to barcode patterns associated with a particular type of barcode.

28. The system of claim 27, wherein generating a digital signature of the message or the digest of the message comprises:
encrypting the message or the digest of the message using a digital key.

29. The system of claim 28, wherein encrypting the message or the digest of the message comprises:
encrypting the message or the digest of the message using a private key associated with an asymmetric public key.

30. The system of claim 29, wherein the barcode information further comprises the public key.

31. The system of claim 30, wherein the barcode information further comprises a public key certificate that includes the public key and identity information associated with the entity to whom the public key certificate has been issued by a Certificate Authority.

32. The system of claim 29, wherein the barcode information further comprises an author identifier.

33. A computer-implemented method of verifying the authenticity of a barcode, comprising:
receiving a verification request from a barcode reading device though a network communication, wherein the verification request comprises a barcode message or message digest, a digital signature, and an author identifier;
retrieving a public key certificate, wherein the public key certificate include signer information corresponding to the author identifier received from the barcode reading device;
decrypting the digital certificate using a public key included in the public key certificate to generate decrypted message data;
determining whether the barcode message is authentic by determining whether the decrypted message data matches the barcode message or message digest; and
transmitting an electronic response to the barcode reading device indicating whether the barcode message is authentic.

34. A method of verifying the authenticity of physical information using a digitally signed barcode, the method comprising:
inputting graphical data representing a barcode pattern into memory, wherein the barcode pattern is affixed to or associated with a physical object that contains a physical message, wherein the physical message comprises information embodied on the physical object apart from the barcode pattern;
translating the graphical data of the barcode pattern into barcode information according to a standard for translating a particular type of barcode pattern into barcode information;
extracting a barcode message and a barcode digital signature from the barcode information;
decrypting the barcode digital signature using a public key corresponding to an assumed author of the physical message; and
determining whether the physical message is authentic by determining whether the decrypted digital signature matches the barcode message and the barcode message matches the physical message.
